(19) United States
(12) Patent Application Publication
(10) Pub. No.: US 2002/0113180 A1
(43) Pub. Date: Aug. 22, 2002

(54) Mounting system for a supporting surface

(76) Inventor: Jacob R. Wiebe, Winnipeg (CA)

Correspondence Address: ADE & COMPANY, 1700-360 MAIN STREET, WINNIPEG, MB, R3C3Z3, CA

(21) Appl. No.: 09/792,005

(22) Filed: Feb. 22, 2001

(51) Int. Cl. A47B 9/00; F16M 11/16

(52) U.S. Cl. 248/188; 108/107; 108/147.13

(57) ABSTRACT

A mounting system is provided for adjustably mounting supporting surfaces in the form of shelves and the like at various relative heights. A plurality of uprights, having indentations therein, are arranged to support respective expandable clamping assemblies thereon. The clamping assemblies include respective indentations along respective inner surfaces thereof for alignment with the indentations of the uprights such that a retainer member can be received between the respective indentations for supporting the clamping assemblies on their respective uprights. The retainer members are spring wires which are biased outwardly to expand the clamping assemblies and release the retainer members from the respective uprights. A plurality of clamping assembly housings are provided for securing the respective clamping assemblies on the uprights in an engaged position. A supporting surface like a shelf is coupled between housings so as to be supported on any one of the indentations spaced longitudinally along the upright corresponding to different relative heights.

### FIELD OF THE INVENTION

This invention relates to a mounting system for a supporting surface and more particularly to a mounting system for adjustably mounting supporting surfaces in the form of shelves and the like at various relative heights.

### BACKGROUND

The use of adjustable mounting systems are known for supporting surfaces including shelves, tables and the like. It is often desired to mount a shelf for example at varying heights depending upon the type of objects to be stored on the shelf.

U.S. Pat. No. 4,318,352 to Friedman et al provides a shelf supported on corner posts having respective spiral indentations therein. Each post includes a clamping assembly thereon having a protrusion arranged to be supported within the spiral indentation for supporting the shelf thereon. The shelf is mounted on retaining members which are wedged onto the respective clamping assemblies for securing the clamping assemblies to the respective posts and supporting the shelf thereon. The clamping assemblies are formed in two halves which require significant separation in order to sufficiently increase the overall inner diameter thereof to release the protrusion from the indentation in the post. This can require significant awkward manipulation on the part of an individual who wishes to release the clamping assembly from the post as the retaining member must be completely be removed from the clamping assembly in order to sufficiently access the clamping assembly for its release. A further problem which may be associated with the clamping assemblies of Friedman is related to the wear of the protrusion resulting from displacement of the device along the post as the entire clamping assembly must be replaced when the protrusion is worn.

### SUMMARY

According to one aspect of the present invention there is provided a supporting surface mounting system comprising:

at least one upright having a first indentation thereon;

said at least one upright including a clamping assembly arranged to be secured thereabout, the clamping assembly having a frusto-conical shaped outer surface and an inner surface arranged to engage said at least one upright, the inner surface including a second indentation therein arranged to be aligned with the first indentation of said at least one upright;

said at least one upright including a retainer member arranged to be received between the second indentation and the first indentation of said at least one upright for supporting the clamping assembly on said at least one upright;

the retainer member of said at least one upright being selectively separable from both the clamping assembly of said at least one upright and said at least one upright;

said at least one upright including a clamping assembly housing arranged to be secured about the respective clamping assembly of said at least one upright, the clamping assembly housing having a frusto-conical shaped inner surface arranged to mate with the frusto-conical shaped outer surface of the clamping assembly for securing the clamping assembly on said at least one upright; and

a supporting surface coupled to the clamping assembly housing of said at least one upright for being supported on said at least one upright.

The retainer member of said at least one upright is preferably formed of a wear resistant material.

The retainer member of said at least one upright is also preferably arranged to be biased outward in a radial direction of said at least one upright so as to be released from said at least one upright.

The first indentation of said at least one upright may comprise a groove extending about a circumference of said at least one upright. The retainer member of said at least one upright in this instance preferably comprises an elongate wire arranged to be received therein, the wire extending substantially about a full circumference of said at least one upright.

The first indentation of said at least one upright may comprise a spiral groove extending along said at least one upright wherein the retainer member of said at least one upright comprises a spiral shaped wire arranged to be received therein. The spiral shaped wire is preferably arranged to extend about a full circumference of said at least one upright.

According to a second aspect of the present invention there is provided a supporting surface mounting system comprising:

at least one upright having an outer mounting surface;

said at least one upright including a clamping assembly arranged to be secured thereabout, the clamping assembly having an inner mounting surface and a frusto-conical shaped outer surface;

the clamping assembly of said at least one upright being arranged to be expandable between an engaged position in which the inner mounting surface is prevented from displacement in a longitudinal direction of said at least one upright in relation to the outer mounting surface of said at least one upright and a disengaged position in which the inner mounting surface is movable in the longitudinal direction in relation to the outer mounting surface;

the clamping assembly of said at least one upright being biased towards the disengaged position;

the clamping assembly of said at least one upright including a clamping assembly housing arranged to be secured about the clamping assembly, the clamping assembly housing having a frusto-conical shaped inner surface arranged to mate with the frusto-conical shaped outer surface of the clamping assembly for securing the clamping assembly in the engaged position; and

a supporting surface coupled to the clamping assembly housing of said at least one upright for being supported on said at least one upright.

The clamping assembly of said at least one upright may include a retainer flange extending outward from a narrow end of the frusto-conical shaped outer surface of the clamping assembly in a radial direction of said at least one upright. In this instance, an outer diameter of the retainer flange of the clamping assembly of said at least one upright in the engaged position of the clamping assembly is preferably less than an inner diameter of the inner surface of the clamping assembly housing at a narrow end of the clamping assembly. Also the outer diameter of the retainer flange in the disengaged position is preferably greater than the inner diameter of the inner surface of the clamping assembly housing at the narrow end of the clamping assembly.

Said at least one upright preferably includes an indentation therein and the clamping assembly of said at least one upright includes a spring member which is arranged to be engaged within the indentation in the engaged position, the spring member being biased towards the disengaged position in which the spring member is disengaged from the indentation.

In one embodiment, the indentation of said at least one upright may comprise a spiral groove and the spring member of the clamping assembly of said at least one upright comprises a spiral spring wire arranged to be supported on the clamping assembly and received within the spiral groove in the engaged position.

In this embodiment, the inner mounting surface of the clamping assembly of said at least one upright preferably includes a spiral indentation therein in alignment with the spiral indentation of said at least one upright arranged to support the spiral spring wire therein, the spiral indentation of the clamping assembly of said at least one upright including terminal ends arranged to engage respective ends of the spiral spring wire when the clamping assembly of said at least one upright is rotated about said at least one upright.

In another embodiment, the indentation of said at least one upright may comprise an annular groove extending about said at least one upright and the spring member of the clamping assembly of said at least one upright comprises an annular spring wire extending substantially about a full circumference of said at least one upright, the annular spring wire being arranged to be supported on the clamping assembly and received within the annular groove in the engaged position.

In this embodiment, the indentation of said at least one upright preferably comprises a plurality of annular grooves spaced along said at least one upright in a longitudinal direction of said at least one upright, each annular groove being arranged to receive the annular spring wire of the clamping assembly of said at least one upright therein.

According to a further aspect of the present invention there is provided a supporting surface mounting system comprising:

at least one upright having an outer mounting surface;

said at least one upright including a clamping assembly arranged to be secured thereabout, the clamping assembly having an inner mounting surface and a frusto-conical shaped outer surface;

the clamping assembly of said at least one upright comprising a sleeve formed of at least three arcuate sections arranged to be coupled together and expanded relative to each other in a radial direction of said at least one upright between an engaged position in which the inner mounting surface is prevented from displacement in a longitudinal direction of said at least one upright in relation to the outer mounting surface of said at least one upright and a disengaged position in which the inner mounting surface is movable in the longitudinal direction in relation to the outer mounting surface;

the clamping assembly of said at least one upright including a clamping assembly housing arranged to be secured about the clamping assembly, the clamping assembly housing having a frusto-conical shaped inner surface arranged to mate with the frusto-conical shaped outer surface of the clamping assembly for securing the clamping assembly in the engaged position; and

a supporting surface coupled to the clamping assembly housing of said at least one upright for being supported on said at least one upright.

In one embodiment, said at least one upright may include a first spiral indentation thereon and the inner mounting surface of the clamping assembly of said at least one upright may include a second spiral indentation thereon arranged to align with the first indentation of the clamping assembly. The clamping assembly in this instance including a spiral retainer member arranged to be received between the first and second spiral indentations.

The second spiral indentation of the clamping assembly of said at least one upright preferably comprises a plurality of spiral grooves on each arcuate section, the plurality of spiral grooves on each arcuate section being aligned with a portion of the spiral grooves of an adjacent section.

The arcuate sections of the clamping assembly of said at least one upright are preferably identical to each other.

The clamping assembly of said at least one upright may be arranged to be biased outward in a radial direction of said at least one upright so as to be released from said at least one upright.

The clamping assembly of said at least one upright may include a retainer flange extending outward from a narrow end of the frusto-conical shaped outer surface of the clamping assembly in a radial direction of said at least one upright.

### BRIEF DESCRIPTION OF THE DRAWINGS

In the accompanying drawings, which illustrate exemplary embodiments of the present invention:

FIG. 1 is an isometric view of a first embodiment of the shelving system.

FIG. 2 is a partly sectional side elevational view of the shelving system according to FIG. 1.

FIG. 3 is a sectional view along the line 3-3 of FIG. 2.

FIG. 4 is a front elevational view of an inner side of the clamping assembly of the shelf system according to FIG. 1.

FIG. 5 is a is a partly sectional side elevational view of a second embodiment of the shelving system.

FIG. 6 is a sectional view along the line 6-6 of FIG. 5.

FIG. 7 is a front elevational view of an inner side of one section of the clamping assembly of the shelf system according to FIG. 5.

### DETAILED DESCRIPTION

Referring to the accompanying drawings, there is illustrated a mounting system generally indicated by reference numeral 10. The mounting system 10 is arranged for adjustably mounting a supporting surface such as a shelf 12 at various relative heights.

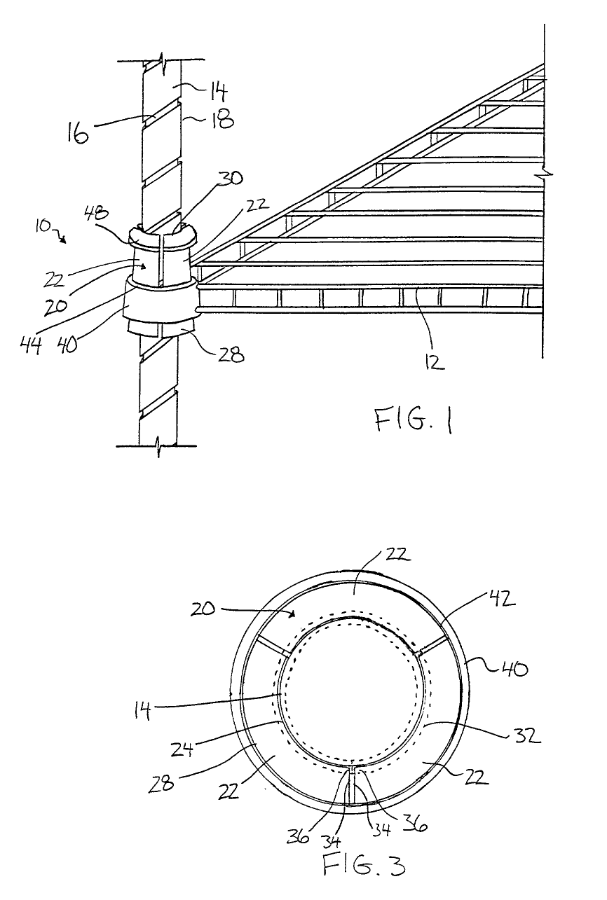

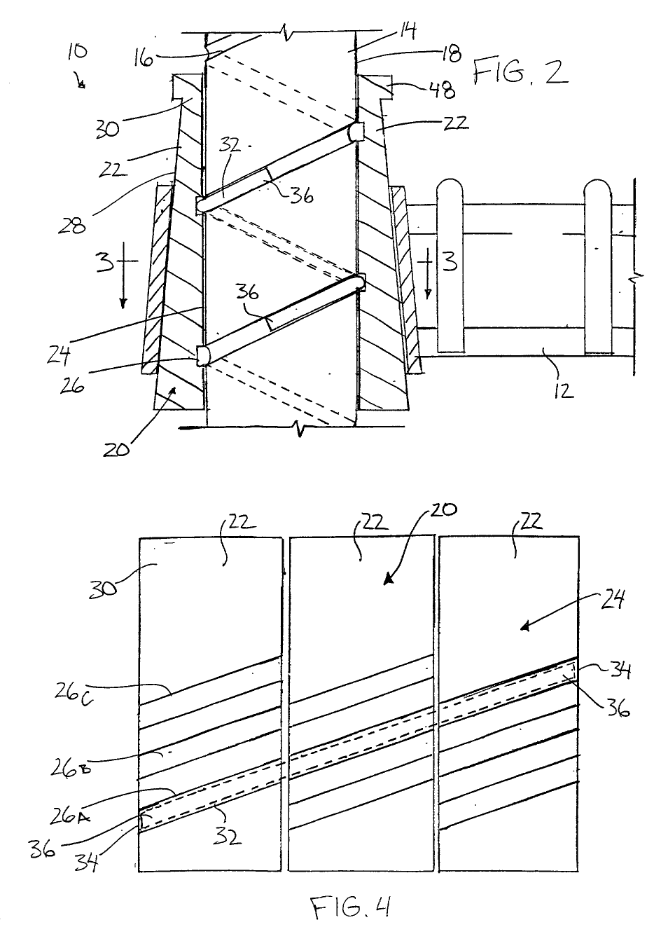

Referring initially to FIGS. 1 through 4 there is illustrated a first embodiment of the mounting system 10. A plurality of uprights 14 are provided for supporting the shelf 12 thereon such that the shelf spans between the uprights. Each upright 14 is an elongate cylindrical post having a spiral indentation 16 about an outer mounting surface 18 of the upright extending the length thereof.

A clamping assembly 20 is mounted about each upright. Each clamping assembly comprises a sleeve formed of three arcuate sections 22, each extending slightly less than 120° about the corresponding upright 14 so as to define a small gap between adjacent sections. When assembled about the upright the sleeve defines an inner mounting surface 24 which is arranged to be supported adjacent the outer mounting surface of the corresponding upright. The inner mounting surface includes a spiral indentation 26 therein which is arranged to be aligned with the spiral indentation 16 of the corresponding upright. An outer surface 28 of each clamping assembly 20 is generally frusto-conical in shape, being narrower at a top end 30 thereof.

A spring retainer member 32 is provided in the form of a spiral-shaped wire which is received within the spiral indentations of both the upright and clamping assembly. A depth of the indentation in the clamping assembly is approximately equal to 70% of the wire thickness for substantially receiving the retainer member 32 therein. A remainder of the wire thickness of the spring retainer member is received within the indentation in the upright when supported thereon.

The three arcuate sections 22 of the clamping assembly are formed identical to each other. Each section includes three grooves which are spaced in a longitudinal direction of the upright thereon. A portion of the grooves align with a portion of the grooves of each adjacent section such that regardless of the order in which the sections are assembled three continuous spiral indentations 26A, 26B, 26C are formed in the inner surface 24 of each clamping assembly, each of which are able to receive the spring retainer member 32 therein. Each continuous spiral indentation includes a pair of terminal ends 34 located at the seam between two adjacent sections. The spring retainer member 32 is thus arranged to complete one full circumference about the upright between the respective terminal ends 34 of the spiral indention 26 of the clamping assembly.

In this arrangement rotation of the clamping assembly in either direction causes a wire end 36 of the retainer member 32 to engage a respective terminal end 34 of the clamping assembly 20 to urge the retainer member to expand in a radial direction about the upright 14. The spring retainer member 32 is also biased outwardly to urge expansion of the clamping assembly in a radial direction of the upright between respective engaged and disengaged positions.

In the engaged position the inner mounting surface of the clamping assembly is held firmly adjacent the outer mounting surface of the corresponding upright with the retainer member being engaged within the spiral indentation of both the clamping assembly and the upright. The clamping assembly is thus prevented from displacement in a longitudinal direction of the upright in relation to the upright by the spring retainer member.

In the disengaged position the retainer member 32 which is biased outwardly expands in a radial direction by becoming partially unwound from the upright sufficiently to disengage the inner mounting surface from the outer mounting surface of the upright and to release the retainer member from the spiral indentation in the upright. The clamping assembly in the disengaged position is thus permitted to be slidably displaced along the upright in a longitudinal direction.

Each clamping assembly 20 includes a clamping assembly housing 40 secured thereabout. The clamping assembly housing 40 is a collar which is fixedly mounted on a respective corner of the shelf 12. The housing 40 and the corresponding clamping assembly 20 are mounted concentrically and co-axially about the corresponding upright 14.

The clamping assembly housing 40 includes a frusto-conical-shaped inner surface 42 which is arranged to mate with the frusto-conical-shaped outer surface 28 of the corresponding clamping assembly 20. The inner surface 42 of the housing is similarly narrower at a top end 44. When the clamping assembly housing 40 is secured about the corresponding clamping assembly 20 and slidably displaced downwardly in relation thereto the clamping assembly is constricted about the upright by the sliding and mating frusto-conical-shaped surfaces. The resulting wedging action from the force of gravity and the force of an individual who pushes the housing down into an engaged position adequately secures the clamping assembly on the corresponding upright.

A retainer flange 46 is mounted on the narrow top end 30 of the clamping assembly 20 to extend radially outward from each of the arcuate sections 22. The retainer flange 46 extends substantially about a full circumference of the upright for supporting the clamping assembly on the respective clamping assembly housing.

The retainer flange is arranged such that an outer diameter thereof in the engaged position of the clamping assembly is less than an inner diameter of the inner surface of the housing 40 at the narrow top end 44 thereof. The outer diameter of the retainer flange 46 is further arranged to be greater than the inner diameter of the inner surface of the housing 40 at the top end 44 thereof in the disengaged position.

In this arrangement the clamping assembly 20 with the spring retainer member 32 mounted therein can be flexed radially inwardly for insertion into the clamping assembly housing 40 upon assembly. Subsequent expansion of the spring retainer member 32 will displace the clamping assembly sections 22 radially outwardly in relation to each other into the disengaged position. In the disengaged position, the retainer flange 46 is supported on a top end 44 of the corresponding clamping assembly housing 40 for securing the clamping assembly 20 of each upright 14 assembled within its respective clamping assembly housing 40.

The clamping assemblies are then aligned with the respective uprights 14 and slidably displaced therealong until the shelf 12 is at an appropriate desired height. To secure the shelf in place each clamping assembly 20 is held in turn while the corresponding comer of the shelf with the housing 40 mounted thereon is lowered in relation to the clamping assembly to wedge the clamping assembly in the engaged position.

For small adjustments of the relative height of one of the corners of the shelf the corresponding clamping assembly housing 40 is loosened to permit rotation of the corresponding clamping assembly 20 about the upright 14 such that the retainer member 32 threaded within the spiral indentation in the upright causes the clamping assembly 20 to be displaced longitudinally along the upright as it is rotated. The terminal ends 34 engage the respective wire ends 36 of the retainer members 32 to assist in expanding the retainer member about the upright for ease of rotation of the clamping assembly in the engaged position.

For larger adjustments of the height of the shelf the entire shelf may be lifted in relation to the clamping assemblies 20 secured to the respective uprights until the respective spring retainer members 32 expand the clamping assemblies within the respective clamping assembly housings 40 thereby releasing the clamping assemblies to permit longitudinal displacement of the shelf along the uprights. When the shelf is repositioned each clamping assembly in turn again is held in relation to the corresponding upright such that the clamping assembly housing 40 may be secured thereon by wedging the frusto-conical surfaces together.

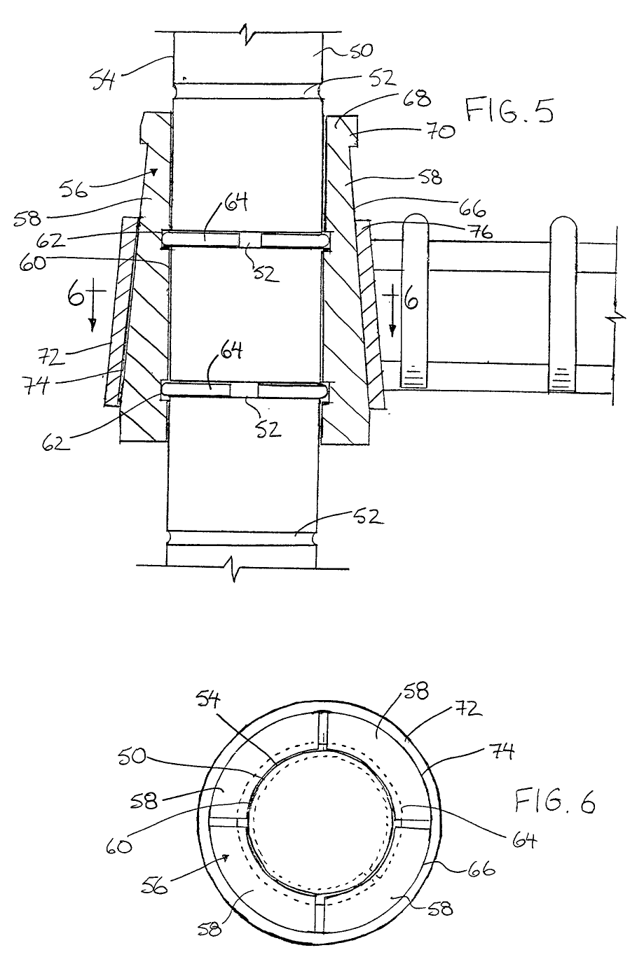

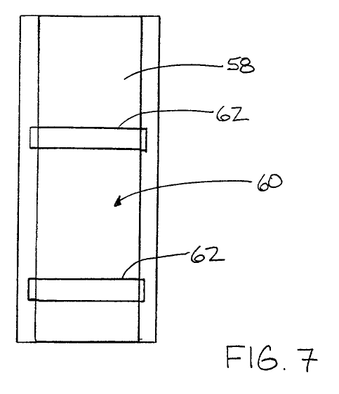

Referring to FIGS. 5 through 7 a second embodiment of the mounting system 10 is illustrated. In the second embodiment a plurality of uprights 50 are provided in which each upright comprises an elongate cylindrical post having a plurality of annular indentations 52 about an outer mounting surface 54 of each respective upright wherein the indentations 52 are spaced along in a longitudinal direction of the uprights.

A clamping assembly 56 is mounted about each upright 50. Each clamping assembly 56 comprises a sleeve formed of four arcuate sections 58 each extending slightly less than 90° about the corresponding upright defining a plurality of gaps therebetween when the sections 58 are assembled about a circumference of the upright.

Each clamping assembly 56 includes an inner mounting surface 60 having a pair of spaced apart annular indentations 62 therein which are arranged to be aligned with a corresponding pair of the annular indentations 52 in the corresponding upright 50.

A C-shaped spring retainer member 64 is received within each of the annular indentations 62 of the clamping assemblies similarly to the previous embodiment for supporting the respective clamping assemblies on the uprights 50. Each spring retainer member 64 extends substantially about a full circumference of the upright 50 while being biased radially outwardly from the upright so as to expand the clamping assemblies 58 similarly to the previous embodiment between an engaged and disengaged position.

In the engaged position the clamping assembly 56 is securely engaged about the upright 50 while the spring retainer members 64 are engaged within their respective annular indentations 52 in the upright to prevent longitudinal displacement of the clamping assemblies in relation to the respective uprights.

In the disengaged position the spring retainer members 64 are expanded such that the sections 58 of the clamping assembly are displaced radially outwardly from the uprights permitting the spring retainer members 64 to be released from the respective annular indentations 52 in the uprights thus permitting longitudinal displacement of the clamping assembly 56 along its respective upright.

Each of the arcuate sections 58 is identical to the adjacent sections 58 such that arcuate grooves formed in each section align with adjacent sections to define the annular indentations 62 therein.

An outer surface 66 of the clamping assembly 56 is generally frusto-conical in shape being narrower at a top end 68. A retainer flange 70 is arranged to extend radially outward from the top end 68 of each section 58 of the clamping assembly such that the retainer flange 70 extends about a full circumference of the clamping assembly similarly to the previous embodiment.

The retainer flange 70 serves to support the clamping assembly 56 within a clamping assembly housing 72 which are located on the corners of the shelf 12 similarly to the previous embodiment. The housing 72 includes a frusto-conical-shaped inner surface 74 which is arranged to mate with the frusto-conical-shaped outer surface 66 of the clamping assembly. The inner surface 74 is narrower at the a top end 76 of the housing and is dimensioned in relation to the retainer flange 70 similarly to the previous embodiment for supporting the clamping assembly 56 within the clamping assembly housing 72. The housing 72 further acts to constrict the clamping assembly 56 about the upright 50 when the mating frusto-conical surfaces are slidably displaced relative to one another to wedge the clamping assembly 56 in the engaged position similarly to the previous embodiment.

In use the clamping assemblies 56 are first assembled within the respective clamp assembly housings 72 and including the respective spring retainer members 64 securing the clamping assemblies 56 in the respective disengaged positions. The clamping assemblies 56 may thus be slidably mounted over the respective uprights 50 until the shelf is supported at a desired height. Each clamping assembly 56 may then be held in place at the desired location such that further lowering of the shelf 12 will urge the clamping assemblies 56 into their respective engaged positions wherein the spring retainer members 64 are supported within the respective annular indentations 52 of the uprights. The spacing of the annular indentations 52 is common to all of the uprights 50 such that the shelf may be easily levelled by mounting the respective clamping assemblies 56 on annular indentations of respective uprights having a common height.

To adjust the height of the shelf or of a single corner of the shelf, the corresponding corner of the shelf is lifted permitting the clamping assembly 56 to be automatically released from the corresponding upright as the pair of spring retainer members 64 therein displace the sections 58 radially outward from the upright. Once the clamping assembly 56 is repositioned holding the clamping assembly while lowering the corresponding clamping assembly housing thereabout will cause the corner of the shelf to be engaged in a new position.

In both embodiments the spring retainer members 32 and 64 remain selectively separable from the corresponding clamping assemblies so as to permit the retainer member to be replaced when worn. Forming the retainer members of a durable wear resistant material such as certain metals also ensures long life of the clamping assemblies with minimal maintenance required.

In further embodiments the clamping assemblies may be formed of three or more arcuate sections. The fewer the number of sections the easier the clamping assemblies are to assemble however at least three sections is desirable to significantly reduce the overall amount of separation required to sufficiently increase the overall diameter of the clamping assembly to release the retainer members and clamping assembly into the disengaged position. When only two sections are provided the amount of separation required is considerably more than when three or four sections is provided and thus only two sections is not preferred.

When employing a spiral-shaped retainer member and it is desirable that each of the arcuate sections be identical to simplify manufacturing, the number of grooves within each section for forming the spiral indentations about the inner mounting surface of the clamping assemblies is required to be at least equal or greater than the overall number of arcuate sections in order to ensure the spiral-shaped retainer member is able to extend the full circumference of the upright. For example, in the first embodiment three arcuate grooves in each of the arcuate sections of the clamping assembly is sufficient for a clamping assembly formed of three arcuate sections. This permits the spiral retainer member to extend about the full circumference of the while the arcuate sections remain identical to each other for ease of manufacturing.

While various embodiments of the present invention have been described in the foregoing, it is to be understood that other embodiments are possible within the scope of the invention. The invention is to be considered limited solely by the scope of the appended claims.

1. A supporting surface mounting system comprising:
at least one upright having a first indentation thereon;
said at least one upright including a clamping assembly arranged to be secured thereabout, the clamping assembly having a frusto-conical shaped outer surface and an inner surface arranged to engage said at least one upright, the inner surface including a second indentation therein arranged to be aligned with the first indentation of said at least one upright;
said at least one upright including a retainer member arranged to be received between the second indentation and the first indentation of said at least one upright for supporting the clamping assembly on said at least one upright;
the retainer member of said at least one upright being selectively separable from both the clamping assembly of said at least one upright and said at least one upright;
said at least one upright including a clamping assembly housing arranged to be secured about the respective clamping assembly of said at least one upright, the clamping assembly housing having a frusto-conical shaped inner surface arranged to mate with the frusto-conical shaped outer surface of the clamping assembly for securing the clamping assembly on said at least one upright; and
a supporting surface coupled to the clamping assembly housing of said at least one upright for being supported on said at least one upright.

2. The system according to claim 1 wherein the retainer member of said at least one upright is formed of a wear resistant material.

3. The system according to claim 1 wherein the retainer member of said at least one upright is arranged to be biased outward in a radial direction of said at least one upright so as to be released from said at least one upright.

4. The system according to claim 1 wherein the first indentation of said at least one upright comprises a groove extending about a circumference of said at least one upright and the retainer member of said at least one upright comprises an elongate wire arranged to be received therein, the wire extending substantially about a full circumference of said at least one upright.

5. The system according to claim 1 wherein the first indentation of said at least one upright comprises a spiral groove extending along said at least one upright and the retainer member of said at least one upright comprises a spiral shaped wire arranged to be received therein.

6. The system according to claim 5 wherein the retainer member of said at least one upright is arranged to extend about a full circumference of said at least one upright.

7. A supporting surface mounting system comprising:
at least one upright having an outer mounting surface;
said at least one upright including a clamping assembly arranged to be secured thereabout, the clamping assembly having an inner mounting surface and a frusto-conical shaped outer surface;
the clamping assembly of said at least one upright being arranged to be expandable between an engaged position in which the inner mounting surface is prevented from displacement in a longitudinal direction of said at least one upright in relation to the outer mounting surface of said at least one upright and a disengaged position in which the inner mounting surface is movable in the longitudinal direction in relation to the outer mounting surface;
the clamping assembly of said at least one upright being biased towards the disengaged position;
the clamping assembly of said at least one upright including a clamping assembly housing arranged to be secured about the clamping assembly, the clamping assembly housing having a frusto-conical shaped inner surface arranged to mate with the frusto-conical shaped outer surface of the clamping assembly for securing the clamping assembly in the engaged position; and
a supporting surface coupled to the clamping assembly housing of said at least one upright for being supported on said at least one upright.

8. The system according to claim 7 wherein the clamping assembly of said at least one upright includes a retainer flange extending outward from a narrow end of the frusto-conical shaped outer surface of the clamping assembly in a radial direction of said at least one upright.

9. The system according to claim 8 wherein:
an outer diameter of the retainer flange of the clamping assembly of said at least one upright in the engaged position of the clamping assembly is less than an inner diameter of the inner surface of the clamping assembly housing at a narrow end of the clamping assembly; and
the outer diameter of the retainer flange in the disengaged position is greater than the inner diameter of the inner surface of the clamping assembly housing at the narrow end of the clamping assembly.

10. The system according to claim 7 wherein said at least one upright includes an indentation therein and the clamping assembly of said at least one upright includes a spring member which is arranged to be engaged within the indentation in the engaged position, the spring member being biased towards the disengaged position in which the spring member is disengaged from the indentation.

11. The system according to claim 10 wherein the indentation of said at least one upright comprises a spiral groove and the spring member of the clamping assembly of said at least one upright comprises a spiral spring wire arranged to be supported on the clamping assembly and received within the spiral groove in the engaged position.

12. The system according to claim 11 wherein the inner mounting surface of the clamping assembly of said at least one upright includes a spiral indentation therein in alignment with the spiral indentation of said at least one upright arranged to support the spiral spring wire therein, the spiral indentation of the clamping assembly of said at least one upright including terminal ends arranged to engage respective ends of the spiral spring wire when the clamping assembly of said at least one upright is rotated about said at least one upright.

13. The system according to claim 10 wherein the indentation of said at least one upright comprises an annular groove extending about said at least one upright and the spring member of the clamping assembly of said at least one upright comprises an annular spring wire extending substantially about a full circumference of said at least one upright, the annular spring wire being arranged to be supported on the clamping assembly and received within the annular groove in the engaged position.

14. The system according to claim 13 wherein the indentation of said at least one upright comprises a plurality of annular grooves spaced along said at least one upright in a longitudinal direction of said at least one upright, each annular groove being arranged to receive the annular spring wire of the clamping assembly of said at least one upright therein.

15. A supporting surface mounting system comprising:
at least one upright having an outer mounting surface;
said at least one upright including a clamping assembly arranged to be secured thereabout, the clamping assembly having an inner mounting surface and a frusto-conical shaped outer surface;
the clamping assembly of said at least one upright comprising a sleeve formed of at least three arcuate sections arranged to be coupled together and expanded relative to each other in a radial direction of said at least one upright between an engaged position in which the inner mounting surface is prevented from displacement in a longitudinal direction of said at least one upright in relation to the outer mounting surface of said at least one upright and a disengaged position in which the inner mounting surface is movable in the longitudinal direction in relation to the outer mounting surface;
the clamping assembly of said at least one upright including a clamping assembly housing arranged to be secured about the clamping assembly, the clamping assembly housing having a frusto-conical shaped inner surface arranged to mate with the frusto-conical shaped outer surface of the clamping assembly for securing the clamping assembly in the engaged position; and
a supporting surface coupled to the clamping assembly housing of said at least one upright for being supported on said at least one upright.

16. The system according to claim 15 wherein said at least one upright includes a first spiral indentation thereon and the inner mounting surface of the clamping assembly of said at least one upright includes a second spiral indentation thereon arranged to align with the first indentation of the clamping assembly, the clamping assembly including a spiral retainer member arranged to be received between the first and second spiral indentations.

17. The system according to claim 16 wherein the second spiral indentation of the clamping assembly of said at least one upright comprises a plurality of spiral grooves on each arcuate section, the plurality of spiral grooves on each arcuate section being aligned with a portion of the spiral grooves of an adjacent section.

18. The system according to claim 17 wherein the arcuate sections of the clamping assembly of said at least one upright are identical to each other.

19. The system according to claim 15 wherein the clamping assembly of said at least one upright is arranged to be biased outward in a radial direction of said at least one upright so as to be released from said at least one upright.

20. The system according to claim 15 wherein the clamping assembly of said at least one upright includes a retainer flange extending outward from a narrow end of the frusto-conical shaped outer surface of the clamping assembly in a radial direction of said at least one upright.
